(19) United States
(12) Patent Application Publication
(10) Pub. No.: US 2021/0386234 A1
(43) Pub. Date: Dec. 16, 2021

(54) Porous Material Filter Systems and Methods for Producing Edible Extractions

(71) Applicant: Omri Almagor, Milano (IT)

(72) Inventor: Omri Almagor, Milano (IT)

(21) Appl. No.: 17/177,493

(22) Filed: Feb. 17, 2021

Related U.S. Application Data
(60) Provisional application No. 63/038,833, filed on Jun. 14, 2020.

(51) Int. Cl. A47J 31/06; B01J 20/02; B01J 20/28; A47J 31/60; B01D 39/20; A23F 5/26

(52) U.S. Cl. CPC A47J 31/06; B01J 20/02; B01J 20/28019; B01J 20/28004; B01D 2239/1241; B01D 39/2031; A23F 5/26; B01D 2239/0407; A47J 31/605

(57) ABSTRACT

Embodiments of systems including and methods employing one or more porous filters to produce consumable extractions by processing at least partially soluble material(s) via solvent(s), including beverages. Other embodiments may be described and claimed.

### TECHNICAL FIELD

Various embodiments described herein relate generally to producing consumable extractions by processing at least partially soluble material(s) via solvent(s), including systems and methods for producing liquid extracts such as beverages.

### BACKGROUND INFORMATION

It may be desirable to provide systems and methods for processing at least partially soluble material(s) via solvent(s) to produce consumable extractions; the present invention provides such systems and methods.

### BRIEF DESCRIPTION OF THE DRAWINGS

FIG. 1A is a simplified diagram of a system that may be employed to produce consumable extractions from at least partially soluble material(s) via improved solvent distribution according to various embodiments.

FIG. 1B is a simplified diagram of another system that may be employed to produce consumable extractions from at least partially soluble material(s) via improved solvent distribution according to various embodiments.

FIG. 1C is a simplified diagram of another system that may be employed to produce consumable extractions from at least partially soluble material(s) via improved solvent distribution according to various embodiments.

FIG. 2A is a simplified diagram of a system that may be employed to produce consumable extractions from at least partially soluble material(s) via improved solute and solvent filtration according to various embodiments.

FIG. 2B is a simplified diagram of another system that may be employed to produce consumable extractions from at least partially soluble material(s) via improved solute and solvent filtration according to various embodiments.

FIG. 3 is a simplified diagram of a system that may be employed to produce consumable extractions from at least partially soluble material(s) via improved solvent distribution and improved solute, solution, and solvent filtration according to various embodiments.

FIG. 4A is a simplified diagram of a porous filter system that may be employed in a system shown in FIGS. 1A-3 and 5A-6E according to various embodiments.

FIG. 4B is a bottom view image of a porous filter system representing area AA shown in FIG. 4A according to various embodiments.

FIG. 4C is an enlarged image of area BB shown in FIG. 4B according to various embodiments.

FIG. 5A is a simplified isometric drawing of a system that may be employed to produce consumable extractions from at least partially soluble material(s) via improved solute and solvent filtration according to various embodiments.

FIG. 5B is a simplified cross-sectional drawing of system shown in FIG. 5A according to various embodiments.

FIG. 5C is a simplified exploded view of system shown in FIG. 5A according to various embodiments.

FIG. 5D is a simplified, isometric, offset, exploded view of system shown in FIG. 5A according to various embodiments.

FIG. 5E is a simplified, isometric exploded view of system shown in FIG. 5A according to various embodiments.

FIG. 6A is a simplified isometric drawing of a system that may be employed to produce consumable extractions from at least partially soluble material(s) via improved solvent distribution and improved solute and solvent filtration according to various embodiments.

FIG. 6B is a simplified cross-sectional drawing of system shown in FIG. 6A according to various embodiments.

FIG. 6C is a simplified exploded view of system shown in FIG. 6A according to various embodiments.

FIG. 6D is a simplified, isometric, offset, exploded view of system shown in FIG. 6A according to various embodiments.

FIG. 6E is a simplified, isometric exploded view of system shown in FIG. 6A according to various embodiments.

FIG. 7A is a simplified isometric diagram of a porous filter system that may be employed in a system shown in FIGS. 1A-C, 3, and 6A-6E according to various embodiments.

FIG. 7B is a simplified cross-sectional drawing of system shown in FIG. 7A according to various embodiments.

FIG. 7C is a simplified exploded view of system shown in FIG. 7A according to various embodiments.

FIG. 7D is a simplified isometric, bottom view diagram of a solvent source interface in FIG. 7A according to various embodiments.

### DETAILED DESCRIPTION

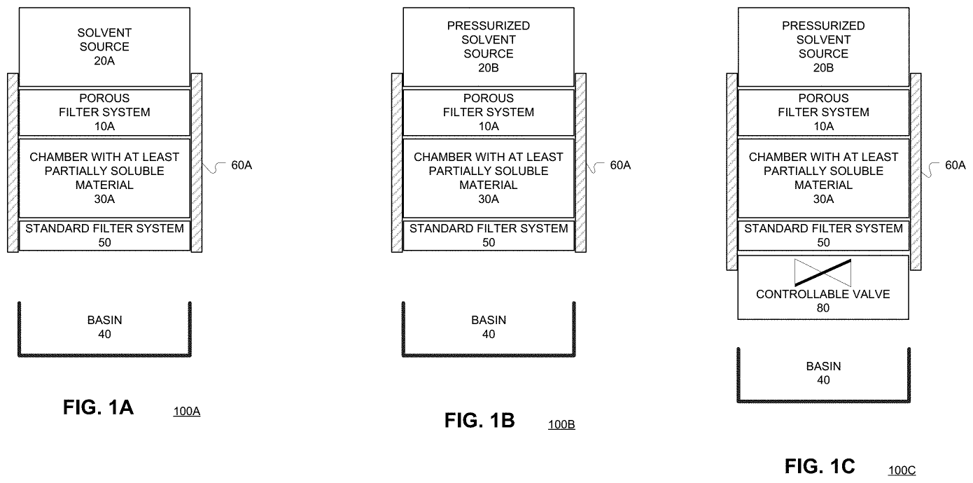

The present invention provides systems and methods that improve the desired extraction of substances from materials via the application of solvent(s) via gravity or greater pressure. In an embodiment, materials having substances to be desirably extracted may be placed in a chamber 30A-C as shown in FIGS. 1A-6E. A solvent 20A may be introduced into the chamber 30A-C to engage the material in the chamber 30A-C. In an embodiment, one or more filter systems 10A, 50 may be placed between the solvent source 20A and chamber 30A-C. A standard filter system 50 may formed of a sheet of metal or metal mesh with 350 to 900 holes may be placed between the solvent source 20A and chamber 30A-C. The standard filter system 50 may distribute the solvent over a larger area of the chamber 30A than without a filter and provide some back-pressure control.

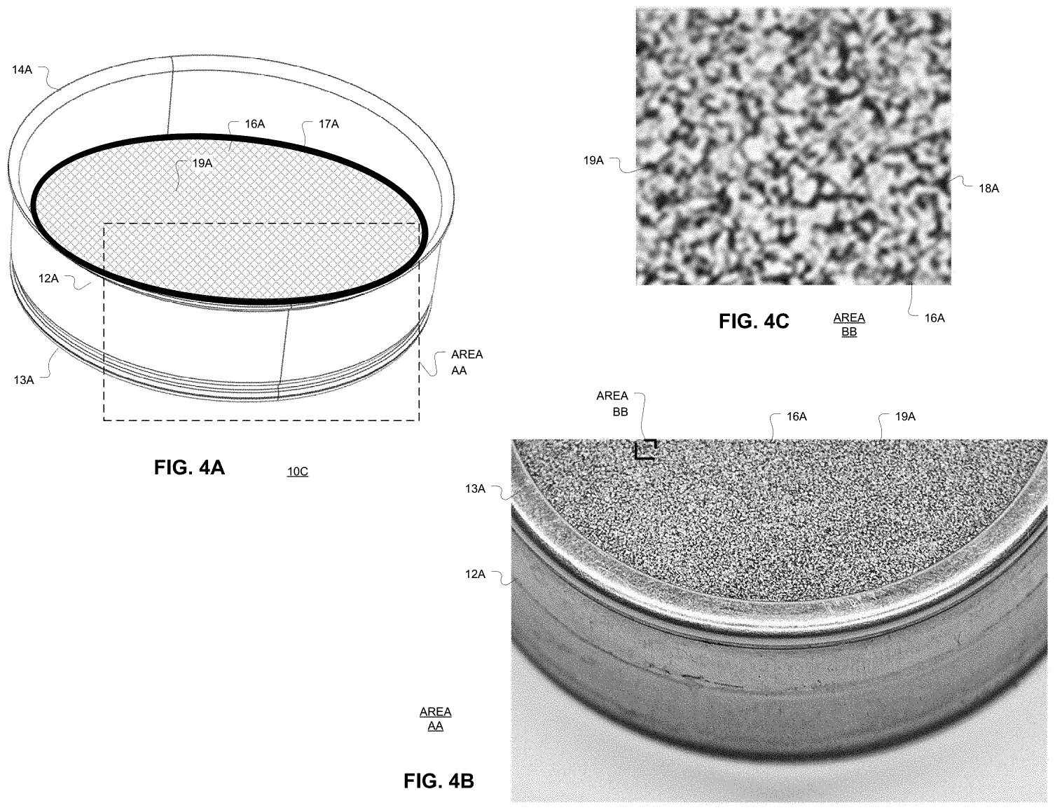

In order to create a greater saturation field and control the solvent source 20A pressure (help regulate) in the field, a porous filter such as shown in FIGS. 4A-4C may be placed between a solvent source 20A and chamber 30A-C as shown in FIGS. 1A-C, 3, and 6A-6E. In an embodiment, the porous filter 16A, 16B of a filter system 10A may be formed of micron sized metal spheres that are compressed to form the porous filter system 10A. In an embodiment, the spheres may have diameter from 1 to 200 microns and about 25 microns for the porous filter 16A, 16B of the filter system 10A in an embodiment. In an embodiment, the spheres may be formed from stainless steel, titanium, ceramics, polymers, or other food safe materials. The porous filter system 10A may be sized according to the chamber 30A-C to be engaged. In an embodiment, the filter system 10A may have a diameter of about 30 to 100 mm.

In an embodiment, a filter system 10A placed between a solvent source 20A and chamber 30A-C may create 30,000 to 100,000 separate solvent channels and about 50,000 channels of about 2 to 3 microns in an embodiment creating a substantial saturation field. The porous filter system 10A may also control the pressure of a solvent field applied by a solvent source 20A, regulating the pressure and creating a more uniform distribution of pressure across a chamber 30A-C.

In an embodiment, it may be desirable to ensure the solvent is contact with the material in the chamber 30A-C for a certain time interval, under a certain pressure, and that only certain substances of the material pass out of the chamber 30A-C (into a container or basin 40) for possible consumption. In order to achieve these goals one or more filter systems 10B, 50, 50B may be placed at the exit of a chamber 30A-C as shown in FIGS. 1A-6E. As noted, a standard filter system 50, 50B may be formed of solid metal or a mesh and have about 300-900 channels. Use of a standard filter system 50, 50B alone at a chamber exit of a system 100A-C, 200A-C, and 300A-B may prevent the passage of some undesirable material but not all and may not enable sufficient pressure to be applied to the material by a solvent or for sufficient time. In an embodiment, a controllable fluid valve 80 may be placed after a standard filter system 50 or porous filter system 10B at the chamber 30A-C exit as shown in FIG. 1C. The controllable fluid valve 80 may be mechanical or electronically controlled and ensure solvent is held in the chamber 30A-C for a predetermined period of time.

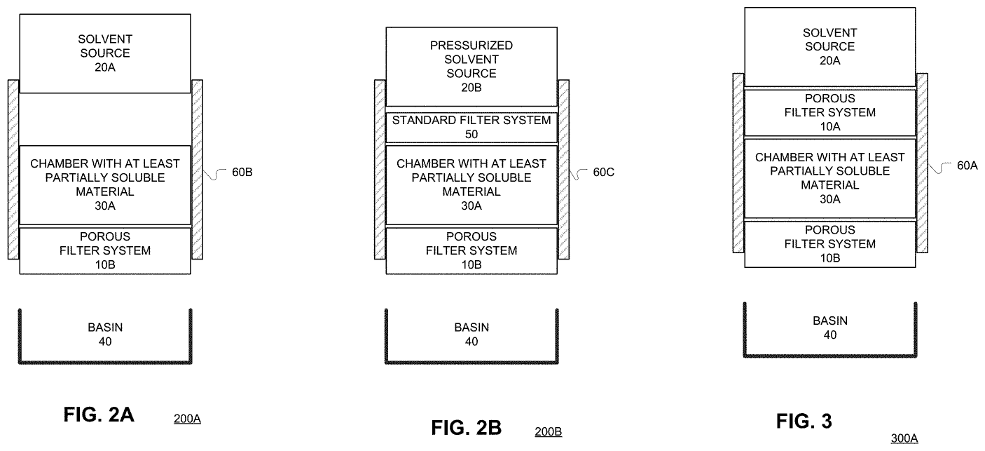

In an embodiment, a filter system 10B with a porous filter 16A, 16B may be employed, alone or in combination with a standard filter system 50, 50B at the exit of a chamber 30A-C as shown in embodiments 200A-C and 300A-B shown in FIGS. 2A-3, and 5A-6E. In an embodiment, the filter system 10B porous filter 16A, 16B may also be formed of micron sized metal spheres that are compressed to form the porous filter 16A, 16B. In an embodiment, the metal spheres may have diameter from 10 to 40 microns and about 15 microns for the filter system 10B in an embodiment. In an embodiment, the metal spheres may be formed from stainless steel, titanium, polymers, ceramics, or other food safe materials. The filter system 10B may be sized according to the chamber 30A-C exit to be engaged. In an embodiment, the filter system 10B may have a diameter of about 5 to 1,000 mm.

In an embodiment, a filter system 10B with a porous filter 16A, 16B may be placed between at a chamber 30A-C exit may create 30,000 to 100,000 separate solvent channels and about 50,000 2-to-3-micron channels in an embodiment creating a very fine filter. The filter system 10B may limit or prevent under desired material in the chamber 30A-C from exiting the chamber. The system 10B with a porous filter 16A, 16B may also control the pressure of solvent applied by a solvent source 20A in the chamber 30A-C enabling a substantial, consistent, and longer application of solvent on material in the chamber 30-C. The filter system 10B with a porous filter 16A, 16B may also create a more uniform distribution of pressure across a chamber 30A-C and thus across material in the chamber.

FIG. 4A is a simplified diagram of a porous filter system 10C that may be employed in a system shown in FIGS. 1A-C, 3, and 5A-6E according to various embodiments as a function of its porous filter 16A, 16B configuration. FIG. 4B is an image of the system 10C porous filter 16A representing an area AA shown in FIG. 4A according to various embodiments. FIG. 4C is an enlarged image of area BB shown in FIG. 4B according to various embodiments. As shown FIGS. 4A-4C, the filter system 10C may include a very dense porous filter 16A with channels 18A on its surface 19A on the order of microns in an embodiment. In application, the porous filter 16A may be coupled to an extended wall 12A via a seal 17A. The wall 12A and lips 14A height and shape may be selected to engage a solvent source 20A, chamber 30A-30C entrance or chamber 30A-30C exit in an embodiment. In an embodiment, the porous filter 16A of a filter system 10A, 10B, 10C may only millimeters in height while the 12A height may be about 10 to 20 millimeters as a function of the system 100A-C, 200A-200C, or 300A-B in which it is employed.

Via such porous filters 16A, 16B, embodiments 100A-C, 200A-C, and 300A-B of FIGS. 1A-1C, 2A-2B, 3, and 5A-6E may be used to create aqueous solutions including brewed beverages where a solvent is water and the material is an at least partially soluble material producing substance(s) that are desirable in water such as oils, acids, organic molecules, caffeine and other substances from coffee beans, teas, or other plant material.

For example, coffee beans are seeds harvested from coffee berries that are ground and brewed (via water) to create beverages (aqueous solution). Ideally, the ground coffee beans are mixed with hot water long enough to form desirable soluble suspended substances from the bean but not so long that other undesirable soluble substances are released, such as bitter compounds. The resultant aqueous solution is ideally separated from the ground coffee beans. Factors for processing materials in a chamber 30A-C include the granularity of the material (fineness of grounds) and the application of the solvent in the chamber 30A-C (water), ratio of solvent to material (water to coffee bean grounds) and the technique used to separate the aqueous solution and the processed materials (grounds).

Usage of the porous filter systems 10A (at the chamber 30A-C entrances to control delivery of solvent—20A) and 10B (at the chamber 30A-C exit to control separation of solution (solvent and dissolved material) from remaining material) help to achieve more desirable material processing factors. In particular, more granular materials (finer grounded material in an embodiment) may be used due to the extremely fine filtering capability of the filter systems 10A, 10B. Further, the upper filter system 10A may enable better saturation of material and uniform, increased pressure across the chamber 30A-C. The uniform, increased pressure possible in a chamber 30A-C via filter systems 10A, 10B may reduce amount of solvent needed, increasing flavor and density by greater saturation of the chamber 30A-C material. For example, a standard filter system 50 may create limited channels in a material, reducing the desired extraction of substances from the material. Finally, the filter system 10B may better separate the aqueous solution from the material in the chamber 30A-C.

In an embodiment, the filter systems 10A, 10B could be employed to produce many different types of coffee beverages as part of an automated machine, additions to semi-automated machines, or for manual beverage production. For example, a system 100A shown in FIG. 1A may be employed in an automated machine to produce consumable extractions from at least partially soluble material(s) via improved solvent distribution according to various embodiments. As shown in FIG. 1A, the system 100A includes a solvent source 20A, porous filter system 10A, chamber 30A for materials to be processed by a solvent (from solvent source 20A), a standard filter system 50, structure 60A, and solution capture—basin 40. In an embodiment the structure 60A may include walls that hold the filter systems 10A, 50, form the chamber 30A, and communicate with the solvent source 20A and collection basin 40. The porous filter 16A of a filter system 10A in system 100A may have larger spheres (about 100 microns or greater) to enable a non-pressurized solvent source 20B in an embodiment.

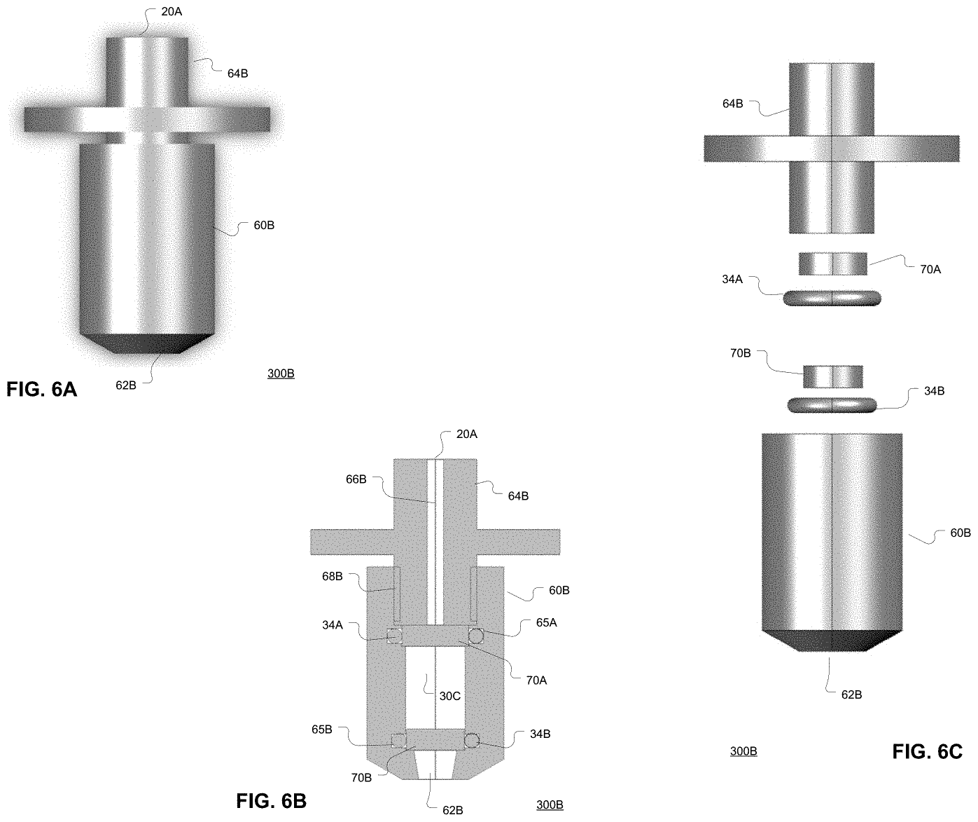

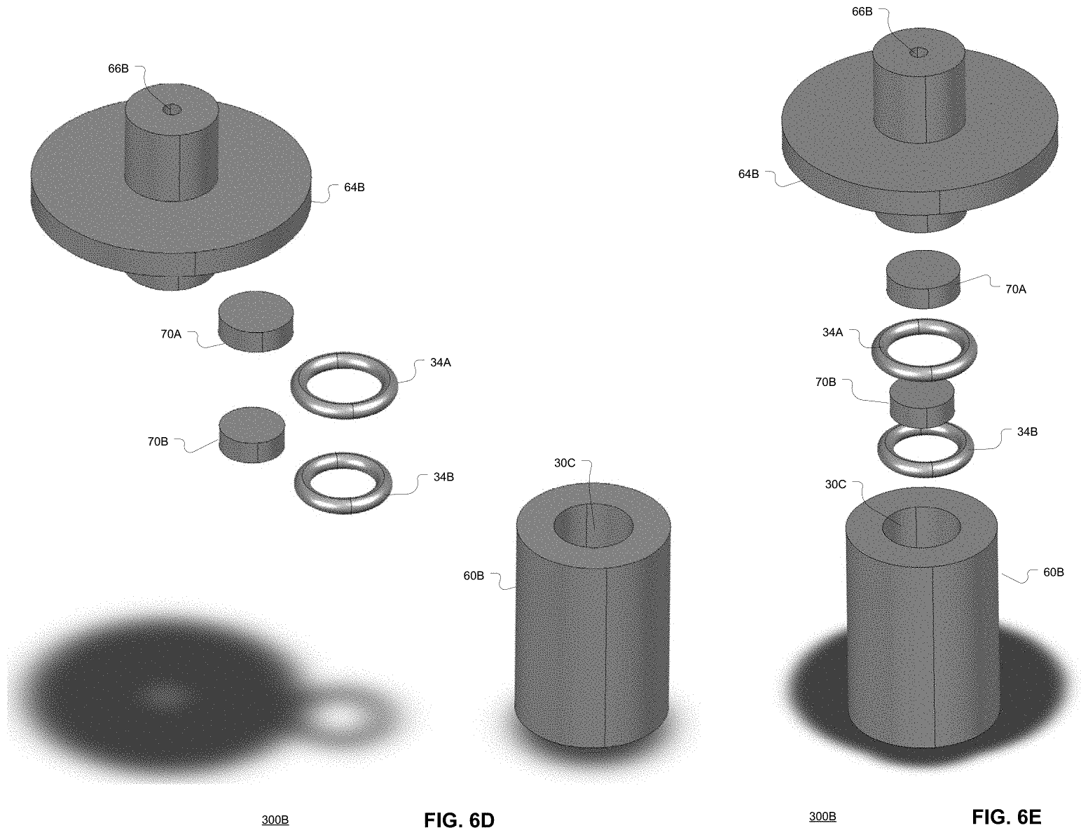

As shown in FIG. 1B, a system 100B similar to 100A may be configured to receive a pressurized solvent source 20B. The porous filter 16A of a filter system 10A in system 10B may have smaller spheres (about 25 microns or less) due to the pressurized solvent source 20B in an embodiment. Both systems 100A, 100B may include seals (34A, 34B in FIGS. 6A-6E for example) to ensure solvent passes through the filter systems 10A, 50 including pressurized solvent. As noted, the placement of the porous filter system 10A between a solvent source 20A and processing chamber 30A may create a more uniform solvent distribution and pressure profile across the chamber 30A and thus any materials in the chamber 30A. As shown in FIG. 1C, in system 100C a controllable fluid valve 80 may be placed after a standard filter system 50 or porous filter system 10B at the chamber 30A-C. The controllable fluid valve 80 may be mechanical or electronically controlled and ensure solvent is held in the chamber 30A-C for a predetermined period of time.

FIG. 2A is a simplified diagram of another system 200A that may be employed to produce consumable extractions from at least partially soluble material(s) via improved solute and solvent filtration via an automated machine or user according to various embodiments. As shown in FIG. 2A, the system 200A includes a solvent source 20A, a porous filter system 10B, a chamber 30A for materials to be processed by a solvent (from solvent source 20A), structure 60A, and solution capture—basin 40. In an embodiment the structure 60A may include walls that hold the filter system 10B to form the chamber 30A, and communicate with the solvent source 20A and collection basin 40. As shown in FIG. 2B, a system 200B similar to system 200A with the addition of a standard filter system 50 may be configured to receive a pressurized solvent source 20B. Both systems 200A, 200B may include seals (34A, 34B in FIGS. 6A-6E for example) to ensure solvent passes through the filter systems 10B, 50 including pressurized solvent. As noted, the placement of the porous filter system 10B at a processing chamber 30A exit may ensure that only desirable solution is passed into the basin 40, keep the solvent in contact with material in the chamber 30A for longer time interval, and help maintain the solvent pressure within a chamber 30A.

FIG. 3 is a simplified diagram of another system 300A that may be employed to produce consumable extractions from at least partially soluble material(s) via improved solute and solvent filtration via an automated machine or user according to various embodiments. As shown in FIG. 3, the system 300A includes a solvent source 20A, a porous filter system 10A, a porous filter system 10B, a chamber 30A for materials to be processed by a solvent (from solvent source 20A), structure 60A, and solution capture—basin 40. In an embodiment the structure 60A may include walls that hold the filter systems 10A, 10B to form the chamber 30A, and communicate with the solvent source 20A and collection basin 40. System 300A may include seals (34A, 34B in FIGS. 6A-6E for example) to ensure solvent including pressurized solvent passes through the filter system 10A and solution passes through filter system 10B. As noted, the placement of the porous filter system 10A between a solvent source 20A and processing chamber 30A may create a more uniform solvent distribution and pressure profile across the chamber 30A.

The placement of the porous filter system 10B at a processing chamber 30A exit may ensure that only desirable solution is passed into the basin 40, keep the solvent in contact with material in the chamber 30A for longer time interval, and help maintain the solvent pressure within a chamber 30A. The combination of both porous filter systems 10A, 10B may create an even greater and uniform solvent distribution and pressure profile in the chamber 30A.

As noted, FIGS. 4A-4C are diagrams of a filter system 10C that may be employed in systems 100A, 100B, 200A, 200B, and 300A shown in FIGS. 1A-3 according to various embodiments. As shown in FIG. 4A, a filter system 10C may include a porous filter 16A coupled to wall 12A having a height and lip 14A. The wall 12A may be configured to engage walls 60A or seals 34A, 34B in an embodiment. A seal 17A may be placed between the inner side of wall 12A and the porous filter 16A in an embodiment. The porous filter 16A may have the characteristics of the porous filter of filter system 10A or 10B. Accordingly, filter system 10C may be employed as filter system 10A, 10B in an embodiment as a function of the characteristics of filter 16A. The seals 34A, 34B, 17A may be formed of any pliable, food safe material including silicon, natural rubber, made-man rubber, plastics, and other polymers. FIG. 4B is an image of a porous filter system 10C representing area AA shown in FIG. 4A according to various embodiments. FIG. 4C is an enlarged image of area BB shown in FIG. 4B according to various embodiments. As shown in FIGS. 4B and 4C, the porous filter 16A provides a very fine filter with micron sized channels 18A.

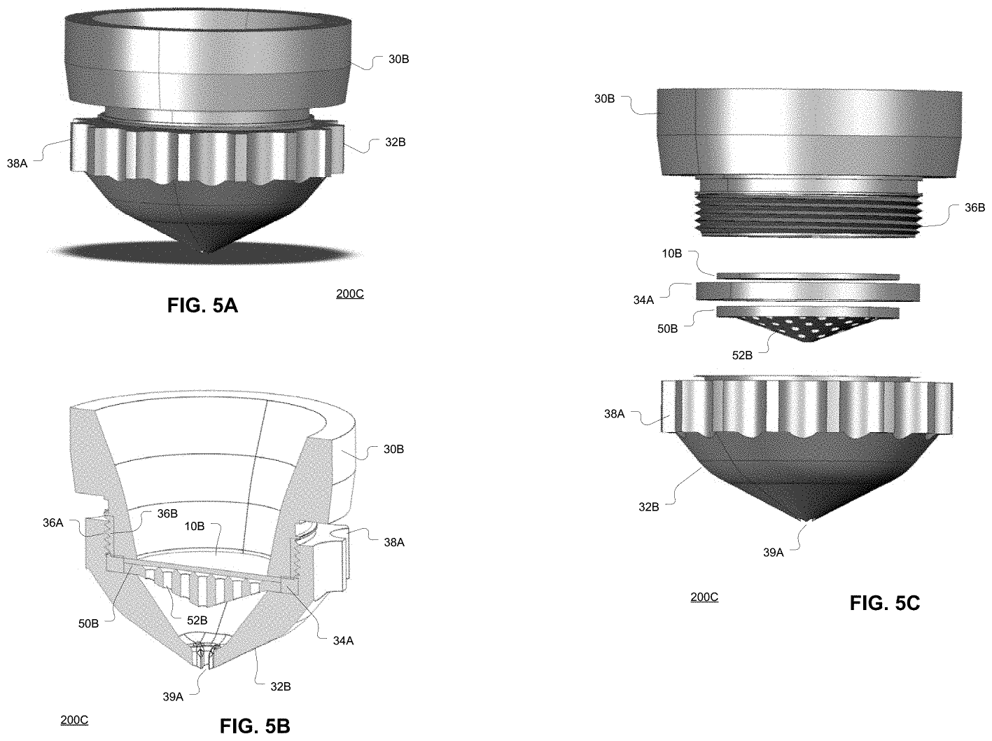

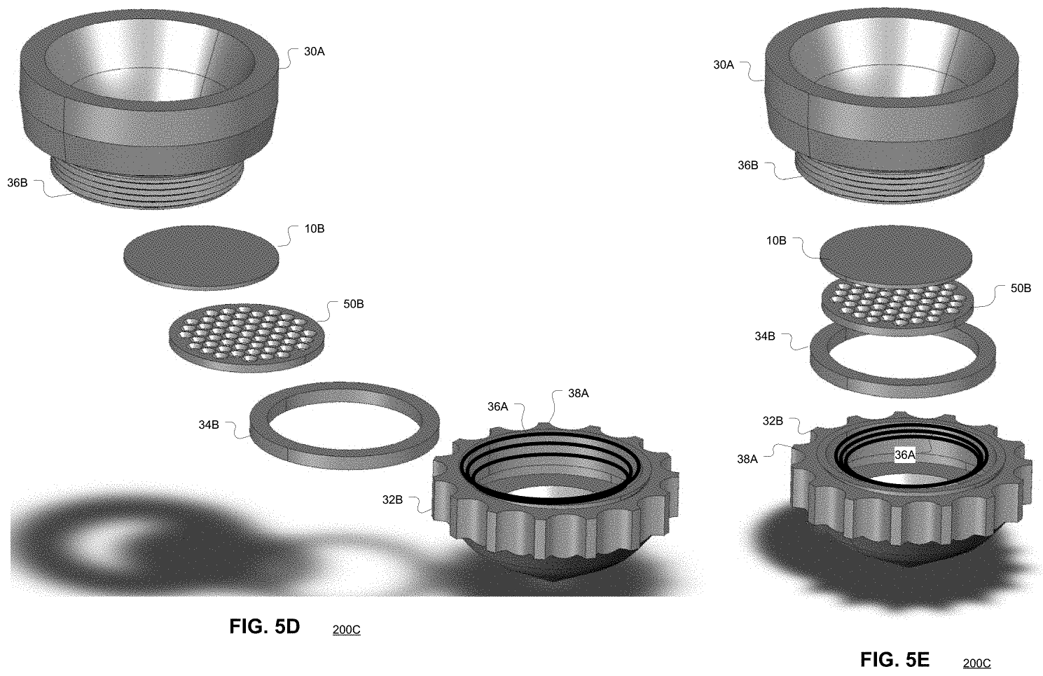

FIGS. 5A-5E are diagrams of a system 200C that be used to provide some or all the features of systems 100A, 100B, 200A, 200B, and 300A shown in FIGS. 1A-3 in an embodiment. FIG. 5A is a simplified isometric drawing of the system 200C. FIG. 5B is a simplified cross-sectional drawing of the system 200C shown in FIG. 5A according to various embodiments. FIG. 5C is a simplified exploded view of the system 200C shown in FIG. 5A according to various embodiments. FIG. 5D is a simplified, isometric, offset, exploded view of the system 200C shown in FIG. 5A according to various embodiments. FIG. 5E is a simplified, isometric exploded view of the system 200C shown in FIG. 5A according to various embodiments.

As shown in FIGS. 5A-5E, the system 200C may include an input chamber section 30B, chamber output section 32B, seal 34A, porous filter system 10B, and standard filter system 50B. The porous filter system 10B, seal 34A and standard metal filter system 50B may be secured between the input chamber section 30B and the chamber output section 32B. In embodiment, the section 30A, 30B may be securely couplable via inner threads 36A on section 32B and outer threads 36B on section 32B. Section 32B may include one or more shaped areas that enable a user to engage the section 32B to form and separate the system 200C as desired. As shown in FIGS. 5A-5C standard filter system 50B may be cone shaped and have a series of channels 52B. The standard filter system 50A may provide support to the porous filter system 10B in an embodiment. In an embodiment, the seal 34A inner diameter may be greater than the outer diameters of the filter systems 10B, 50B and the seal 34A placed in the chamber output section 34B after the filter systems 10B, 50B.

FIGS. 6A-6E are diagrams of a system 300B that is configurable to provide the features of systems 100A, 100B, 200A, 200B, and 300A shown in FIGS. 1A-3 in an embodiment. FIG. 6B is a simplified cross-sectional drawing of the system 300B shown in FIG. 6A according to various embodiments. FIG. 6C is a simplified exploded view of the system 300B shown in FIG. 6A according to various embodiments. FIG. 6D is a simplified, isometric, offset, exploded view of the system 300B shown in FIG. 6A according to various embodiments. FIG. 6E is a simplified, isometric exploded view of the system 300B shown in FIG. 6A according to various embodiments.

As shown in FIG. 6A-6E, the system 300B may include main body 60B, solvent-chamber interface 64B, seals 34A, 34B, and filter systems 70A, 70B. The main body 60B may form a processing chamber 30C, seal channels 65A, 65B, and chamber exit or spout 62B. The solvent-chamber interface 64B may include a channel 66B that communicates with the chamber 30C and a solvent source 20A. The filter systems 70A, 70B may be optionally installed in chamber 30C via seals 34A, 34B and channels 65A, 65B. In an embodiment a filter system 70A may include a porous filter system 10A, a standard filter system 50, or a combination both. In an embodiment a filter system 70B may include a porous filter system 10B, a standard filter system 50, or a combination both. Depending on the installation and selection of elements of filter systems 70A, 70B, system 300B could be configured to function as systems 100A, 100B, 200A, 200B, and 300A shown in FIGS. 1A-3 in an embodiment.

In an embodiment, the systems 100A, 100B, 200A-C, and 300A-B shown in FIGS. 1A-6E may be employed in an automated, semi-automated, or manual beverage generation machine including an espresso machine in an embodiment. For example, elements of systems 100A, 100B, 200A-C, and 300A-B shown in FIGS. 1A-6E may be incorporated into brew unit of an automated espresso machine or a portafilter of a semi-automated espresso machine. In an espresso machine, hot pressurized and vaporized water may be introduced through ground coffee via a system 100A, 100B, 200A-C, and 300A-B shown in FIGS. 1A-6E. System 100A, 100B, 200A-C, and 300A-B shown in FIGS. 1A-6E may be able to support high pressure solvent sources 20A including espresso generation pressures of about 9 bar.

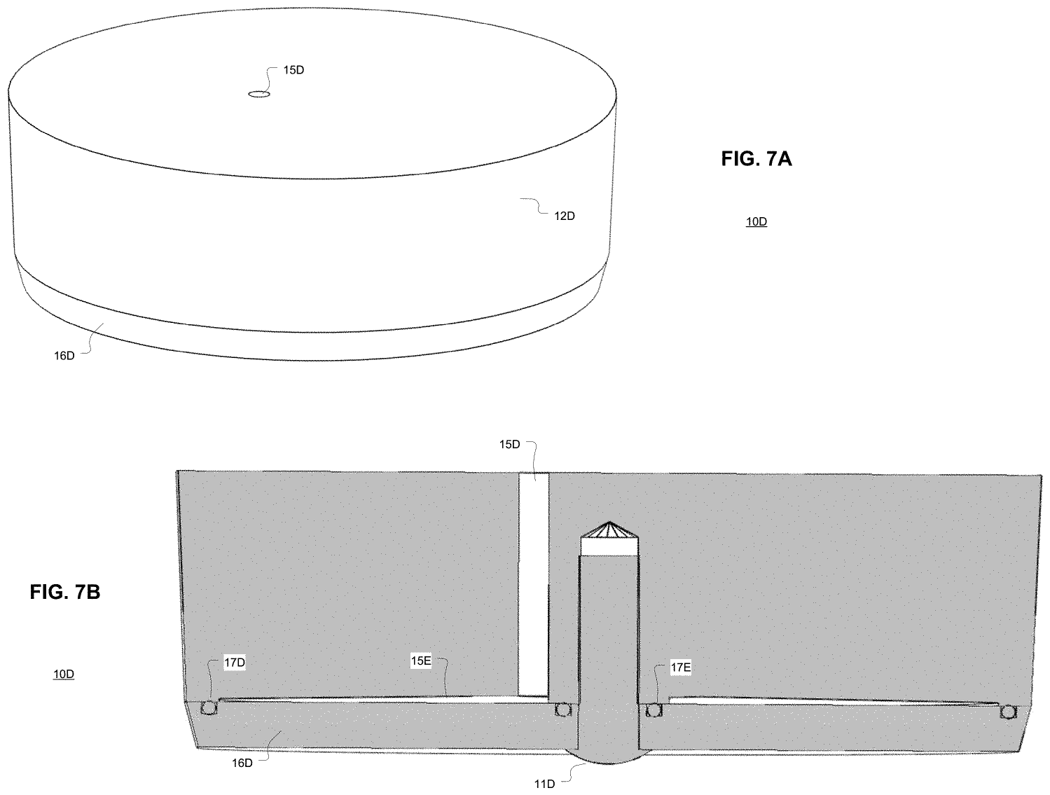

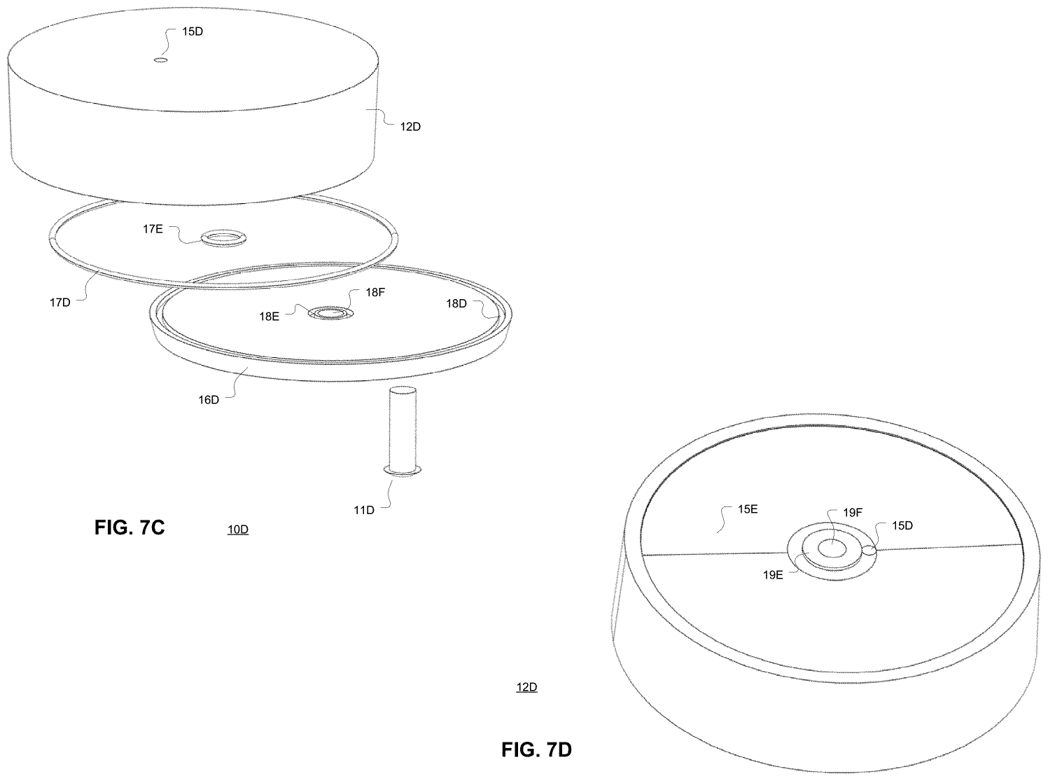

Other embodiments of porous filter systems including a porous filter to filter a solvent may employed in a system 100A, 100B, and 300B such as the porous filter system 10D shown in FIGS. 7A-7D. FIG. 7A is a simplified isometric diagram of a porous filter system 10D that may be employed in a system shown in FIGS. 1A-C, 3, and 6A-6E according to various embodiments. FIG. 7B is a simplified cross-sectional drawing of the porous filter system 10D shown in FIG. 7A according to various embodiments. FIG. 7C is a simplified exploded view of the porous filter system 10D shown in FIG. 7A according to various embodiments. FIG. 7D is a simplified isometric, bottom view diagram of a solvent source interface 12D of a porous filter system 10D in FIG. 7A according to various embodiments.

As shown in FIGS. 7A-7D, the porous filter system 10D includes a solvent source interface 12D coupled to a porous filter 16D via several gaskets 17D, 17E, and a locking mechanism 11D. As shown in FIG. 7B, the combination of the interface, porous filter 16D, several gaskets 17D, 17E, and a locking mechanism 11D form a solvent or fluid channel 15E via interface's 12D port 15D. The bottom of the interface 12D may include a fenestration or opening 19F for the locking mechanism 11D and a raised area 19E to seat against the inner gasket 17E and ensure a fluid pathway 15E across the porous filter 16D as shown in FIG. 7D. As shown in the FIG. 7C, the porous filter 16D may include channels 18D, 18E formed in partial relief to the gaskets 17D, 17E.

In an embodiment, the porous filter 16D may have include compressed spheres having a diameter of about 20 to 60 microns and about 40 microns in an embodiment. The filter 16D may have about 10 to 20 layers of spheres in an embodiment. The interface 12D may be formed of a polymer, ceramics, metals, or alloys including brass in an embodiment. The locking mechanism may be a threaded bolt and the interface 12D may including mating receiving threads in the fenestration 19F. In operation, the porous system 10D may be used in a system providing a solvent to be distributed over an at least partially soluble material. In an embodiment, the porous filter system 10D may employed in an espresso machine to provide to water to coffee grounds where the water is distributed over thousand of channels and with an even pressure.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. An improvement to a system for producing a consumable extraction at a chamber exit by processing an at least partially soluble material in the chamber via a solvent introduced into the chamber entrance via a solvent source, the improvement including a porous filter placed between the solvent source and the chamber entrance to process the solvent prior to entering the chamber.

2. The improvement to a system of claim 1, wherein the porous filter is comprised of spheres having a diameter of about 1 to 00 microns.

3. The improvement to a system of claim 1, wherein the porous filter is comprised of spheres having a diameter of about 25 to 40 microns.

4. The improvement to a system of claim 1, wherein the porous filter is comprised of metal spheres having a diameter of about 25 to 40 microns.

6. The improvement to a system of claim 1, wherein the at least partially soluble material is coffee beans.

7. The improvement to a system of claim 1, wherein the consumable extraction is a beverage.

8. An improvement to a system for producing a consumable extraction at a chamber exit by processing an at least partially soluble material in the chamber via a solvent introduced into the chamber entrance via a solvent source, the improvement including a porous filter placed at the chamber exit to process the consumable extraction.

9. The improvement to a system of claim 8, wherein the porous filter is comprised of spheres having a diameter of about 5 to 100 microns.

10. The improvement to a system of claim 8, wherein the porous filter is comprised of spheres having a diameter of about 15 microns.

11. The improvement to a system of claim 8, wherein the porous filter is comprised of metal spheres having a diameter of about 15 microns.

12. The improvement to a system of claim 10, wherein the consumable extraction is a beverage.

13. An improvement to a method of producing a consumable extraction at a chamber exit by processing an at least partially soluble material in the chamber by introducing a solvent into the chamber entrance from a solvent source, the improvement including processing the solvent from the solvent source via a porous filter placed between the solvent source and the chamber entrance prior to introducing the solvent into the chamber entrance.

14. The improvement to a method of claim 13, wherein the porous filter is comprised of spheres having a diameter of about 25 to 40 microns.

15. The improvement to a method of claim 14, wherein the at least partially soluble material is coffee beans and the consumable extraction is a beverage.

16. The improvement to a method of claim 15, wherein the porous filter is comprised of metal spheres having a diameter of about 25 to 40 microns.

17. An improvement to a method of producing a consumable extraction at a chamber exit by processing an at least partially soluble material in the chamber by introducing a solvent into the chamber entrance from a solvent source, the improvement including processing the consumable extraction via a porous filter placed at the chamber exit.

18. The improvement to a method of claim 17, wherein the porous filter is comprised of spheres having a diameter of about 15 microns.

19. The improvement to a method of claim 18, wherein the at least partially soluble material is coffee beans and the consumable extraction is a beverage.

20. The improvement to a method of claim 19, wherein the porous filter is comprised of metal spheres having a diameter of about 15 microns.
